(19) United States
(12) Patent Application Publication
(10) Pub. No.: US 2017/0325195 A1
(43) Pub. Date: Nov. 9, 2017

(54) WIRELESS COMMUNICATIONS SYSTEM, WIRELESS APPARATUS, AND PROCESSING METHOD

(71) Applicant: FUJITSU LIMITED, Kawasaki-shi (JP)

(72) Inventors: Tetsuya YANO, Yokohama (JP); Takayoshi ODE, Yokohama (JP); Yoshiaki OHTA, Yokohama (JP); Shinichiro AIKAWA, Yokohama (JP); Tsuyoshi SHIMOMURA, Yokohama (JP); Michiharu NAKAMURA, Yokosuka (JP)

(73) Assignee: FUJITSU LIMITED, Kawasaki-shi (JP)

(21) Appl. No.: 15/659,069

(22) Filed: Jul. 25, 2017

Related U.S. Application Data
(63) Continuation of application No. PCT/JP2015/053433, filed on Feb. 6, 2015.

(51) Int. Cl. H04W 68/02; H04W 28/08; H04W 74/08; H04W 76/04

(52) U.S. Cl. CPC H04W 68/02; H04W 76/04; H04W 28/08; H04W 74/0833

(57) ABSTRACT

A wireless communications system includes a first wireless apparatus and a second wireless apparatus. The first wireless apparatus transmits a paging message that includes information indicating a plurality of cells. The paging message causes the second wireless apparatus to transition from an idle state to a connected state. The second wireless apparatus perform processing of connecting to a cell selected based on the information included in the paging message transmitted from the first wireless apparatus.

### CROSS REFERENCE TO RELATED APPLICATIONS

This application is a continuation application of International Application PCT/JP2015/053433, filed on Feb. 6, 2015, and designating the U.S., the entire contents of which are incorporated herein by reference.

### FIELD

The embodiments discussed herein are related to a wireless communications system, a wireless apparatus, and a processing method.

### BACKGROUND

Conventionally, in a cellular mobile communications system, for example, paging is known as a call operation when a call is received at a mobile station. According to another known technique, a wireless base station uses a paging message and notifies a mobile station of a cell whose system information (SI) has changed, (for example, refer to Japanese Laid-Open Patent Publication No. 2011-234252).

According to another known technique, a femto base station uses a broadcast message or a paging message and transmits to a terminal, denial of service information indicating that service cannot be provided (for example, refer to Published Japanese-Translation of PCT Application, Publication No. 2012-532554). According to another known technique, priority information indicating priority in cell reselection is transmitted by the broadcast message (for example, refer to Japanese Laid-Open Patent Publication No. 2012-249324).

### SUMMARY

According to an aspect of an embodiment, a wireless communications system includes a first wireless apparatus and a second wireless apparatus. The first wireless apparatus transmits a paging message that includes information indicating plural cells. The paging message causes the second wireless apparatus to transition from an idle state to a connected state. The second wireless apparatus performs processing of connecting to a cell selected based on the information included in the paging message transmitted from the first wireless apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example of a wireless communications system according to a first embodiment;

FIG. 2 is a diagram depicting an example of signal flow in the wireless communications system depicted in FIG. 1;

FIG. 3 is a flowchart depicting an example of processing by a first wireless apparatus according to the first embodiment;

FIG. 4 is a flowchart depicting an example of processing by a second wireless apparatus according to the first embodiment;

FIG. 5 is a diagram depicting an example of a wireless communications system according to a second embodiment;

FIG. 6 is a diagram depicting an example of a base station according to the second embodiment;

FIG. 7 is a diagram depicting an example of signal flow in the base station depicted in FIG. 6;

FIG. 8 is a diagram depicting an example of a hardware configuration of a base station;

FIG. 9 is a diagram depicting an example of a terminal according to the second embodiment;

FIG. 10 is a diagram depicting an example of signal flow in the terminal depicted in FIG. 9;

FIG. 11 is a diagram depicting an example of a hardware configuration of a terminal;

FIG. 12 is a flowchart depicting an example of processing by a base station according to the second embodiment;

FIG. 13 is a flowchart depicting an example of processing by a terminal according to the second embodiment;

FIG. 14 is a sequence diagram depicting an example of processing by a wireless communications system according to the second embodiment;

FIG. 15 is a diagram depicting an example of a paging message;

FIG. 16 is a diagram depicting another example of the paging message;

FIG. 17 is a diagram depicting an example of a broadcast information update interval;

FIG. 18 is a diagram depicting a first modified example of a wireless communications system according to the second embodiment;

FIG. 19 is a diagram depicting a second modified example of a wireless communications system according to the second embodiment;

FIG. 20 is a diagram depicting an example of a wireless communications system according to the third embodiment;

FIG. 21 is a flowchart depicting an example of processing by a base station according to the third embodiment;

FIG. 22 is a flowchart depicting an example of processing by a terminal according to the third embodiment; and

FIG. 23 is a sequence diagram depicting an example of processing by a wireless communications system according to the third embodiment.

### DESCRIPTION OF THE INVENTION

Embodiments of a wireless communications system, a wireless apparatus, and a processing method according to the present invention will be described in detail with reference to the accompanying drawings.

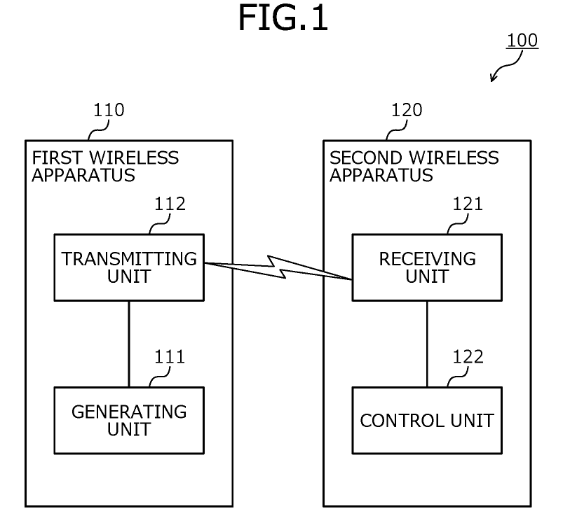

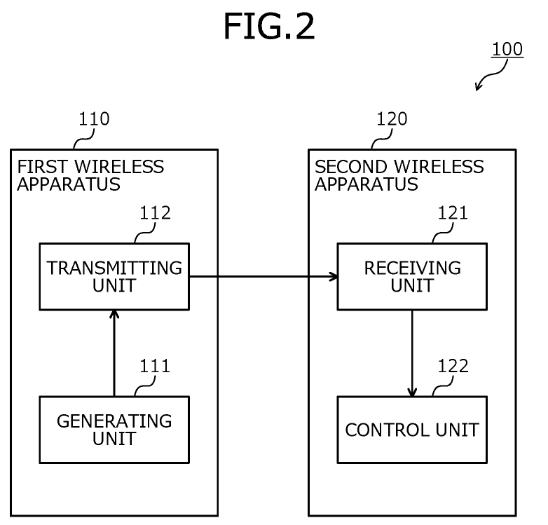

FIG. 1 is a diagram depicting an example of a wireless communications system according to a first embodiment. FIG. 2 is a diagram depicting an example of signal flow in the wireless communications system depicted in FIG. 1. As depicted in FIGS. 1 and 2, a wireless communications system 100 according to the first embodiment includes a first wireless apparatus 110 and a second wireless apparatus 120.

The first wireless apparatus 110 is a wireless communications apparatus provided with a generating unit 111 and a transmitting unit 112. For example, the first wireless apparatus 110 is a base station that performs wireless communication with a terminal. The generating unit 111 generates a paging message that causes the second wireless apparatus 120 to transition from a standby state to a connected state and outputs the generated paging message to the transmitting unit 112.

The transmitting unit 112 wirelessly transmits to the second wireless apparatus 120, the paging message output from the generating unit 111. For example, the transmitting unit 112 wirelessly transmits the paging message destined for the second wireless apparatus 120 to a cell formed by the first wireless apparatus 110. As a result, when the second wireless apparatus 120 is present in the cell formed by the first wireless apparatus 110, the paging message transmitted from the transmitting unit 112 is received by the second wireless apparatus 120.

The standby state is, for example, a state of monitoring signals transmitted in a cell formed by a base station and standing by for a call of the first wireless apparatus 110. For example, the standby state is an idle state of radio resource control. The connected state is, for example, a state of being connected to a network via a base station and being able to communicate. For example, the connected state is a connected state of the radio resource control.

Generation and transmission of a paging message by the first wireless apparatus 110 is performed, for example, when there is a call of the second wireless apparatus 120 from an upper station of the first wireless apparatus 110. The call of the second wireless apparatus 120 occurs as a result of, for example, an incoming voice call for the second wireless apparatus 120 or an incoming signal such as mail for the second wireless apparatus 120.

Information included in the paging message generated by the generating unit 111 is information related to a cell to which the second wireless apparatus 120 is connected. The information related to a cell to which the second wireless apparatus 120 is connected is, for example, information indicating plural cells. The plural cells are, for example, plural cells included among cells formed by the first wireless apparatus 110. The plural cells may include a cell formed by a wireless apparatus different from the first wireless apparatus 110. For example, the plural cells may include cells formed by plural base stations disposed at different locations. The plural cells may include both plural cells formed by the first wireless apparatus 110 and plural cells formed by a wireless apparatus different from the first wireless apparatus 110.

The plural cells are, for example, cells each having a different frequency and including geographically overlapping portions. For example, the plural cells may be cells of a same size each having a different frequency or cells differing from each other in frequency and size. The plural cells may include a cell to which the second wireless apparatus 120 cannot connect due to the second wireless apparatus 120 not being in the cell or due to a lower communication quality at the second wireless apparatus 120.

The paging message generated by the generating unit 111 may be a paging message indicating plural cells and including information that can specify connection priorities in the plural cells. The information included in the paging message is, for example, information that includes identification information of each of the plural cells and information directly indicating priorities of the plural cells. The information directly indicating priorities of the plural cells is, for example, correspondence information of identification information of the plural cells and the priorities of the plural cells.

Alternatively, information included in the paging message may be, for example, information in the form of identification information of the plural cells, arranged sequentially according to the connection priorities in the plural cells. This enables the priorities to be specified, based on the arrangement sequence of identification information in the information included in the paging message, without the information directly indicating the priorities being included in the paging message. For this reason, increases in the data size of the paging message can be suppressed. The sequence according the priorities may be in ascending order or descending order of the priorities.

The paging message generated by the generating unit 111 is, for example, a paging message that includes information indicating a cell selected from among connection candidate cells, based on the load statuses of cells as connection candidates. The load statuses used in selecting a cell can be, for example, various types of statuses such as the radio resource use rate of a cell, the number of terminals currently connected to cells, and the data retention amount (buffering amount) in a cell.

The connection candidate cells are, for example, plural cells included among cells formed by the first wireless apparatus 110. The connection candidate cells may include a cell formed by a wireless apparatus different from the first wireless apparatus 110. The connection candidate cells are, for example, plural cells each having a different frequency and including geographically overlapping portions. The connection candidate cells may include a cell to which the second wireless apparatus 120 cannot connect, due to the second wireless apparatus 120 not being in the cell or due to a lower communication quality at the second wireless apparatus 120.

For example, when connection candidate cells include a cell formed by a wireless apparatus different from the first wireless apparatus 110, the generating unit 111 receives from the wireless apparatus, information indicating the load status of the cell formed by the wireless apparatus. On the basis of the received information indicating the load status, the generating unit 111 then selects from among the connection candidate cells, plural cells indicated by information included in the paging message.

The second wireless apparatus 120 is a wireless communications apparatus provided with a receiving unit 121 and a control unit 122. For example, the second wireless apparatus 120 is a terminal that performs wireless communication with a base station. The receiving unit 121 receives a paging message wirelessly transmitted from the first wireless apparatus 110 and outputs the received paging message to the control unit 122.

The control unit 122 selects a connection-destination cell, based on cell information related to connection of the second wireless apparatus 120, included in the paging message output from the receiving unit 121. The selection of a connection-destination cell by the control unit 122 will be described later. The control unit 122 performs processing of connecting to the cell selected as a connection destination. For example, the control unit 122 performs connection processing of transmitting to a base station (e.g., the first wireless apparatus 110) forming the cell selected as a connection destination, a signal requesting connection to the cell selected as a connection destination. The signal requesting connection is a random access channel signal, for example.

Information included in a paging message will be described next. For example, the first wireless apparatus 110 transmits a paging message that includes information (e.g., plural preferable cell IDs) indicating plural cells to which the second wireless apparatus 120 is to preferentially connect. In this case, when at least any one of the plural cells indicated by the information included in the paging message satisfies a predetermined condition, the second wireless apparatus 120 performs processing of connecting to a cell satisfying the predetermined condition among the plural cells. If none of the plural cells satisfies the predetermined condition, the second wireless apparatus 120 performs processing of connecting to a cell different from the plural cells among cells to which the second wireless apparatus 120 can connect. The predetermined condition is, for example, a condition related to communication quality at the second wireless apparatus 120. The communication quality at the second wireless apparatus 120 is, for example, a communication quality that can be calculated based on the result of reception of a cell wireless signal by the second wireless apparatus 120.

Alternatively, the first wireless apparatus 110 may transmit a paging message that includes information (e.g., plural unfavorable IDs) indicating plural cells to which connection is to be preferentially avoided by the second wireless apparatus 120. In this case, when a cell different from the plural cells among connectable cells satisfies a predetermined condition, the second wireless apparatus 120 performs processing of connecting to the different cell. When the different cell does not satisfy the predetermined condition, the second wireless apparatus 120 performs processing of connecting to at least any of the plural cells.

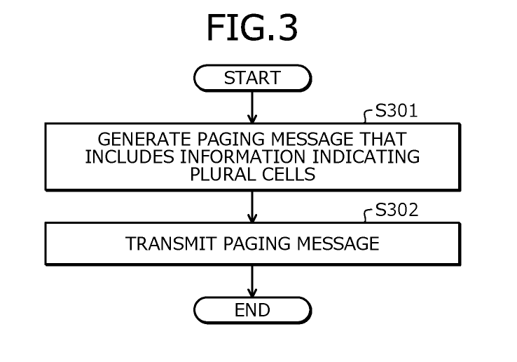

FIG. 3 is a flowchart depicting an example of processing by the first wireless apparatus according to the first embodiment. The first wireless apparatus 110 according to the first embodiment executes steps depicted in FIG. 3, for example. First, the first wireless apparatus 110 generates a paging message that causes the second wireless apparatus 120 to transition from a standby state to a connected state and that includes information indicating plural cells (step S301).

Information included in the paging message by the first wireless apparatus 110 at step S301 is, for example, information indicating plural cells to which the second wireless apparatus 120 is to preferentially connect or information indicating plural cells to which connection is to be preferentially avoided by the second wireless apparatus 120. The plural cells to which the second wireless apparatus 120 is to preferentially connect or the plural cells to which connection is to be preferentially avoided by the second wireless apparatus 120 are, for example, plural cells selected by the first wireless apparatus 110, based on the load statuses of connection candidate cells.

Next, the first wireless apparatus 110 transmits the paging message destined for the second wireless apparatus 120 and generated at step S301 (step S302), ending a series of operations. As a result, the first wireless apparatus 110 can transmit to the second wireless apparatus 120, a paging message that includes information indicating plural cells related to connection of the second wireless apparatus 120.

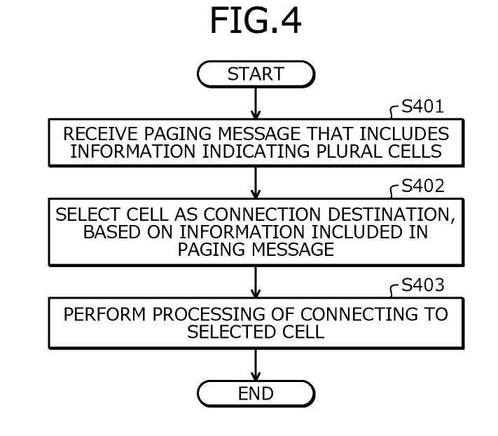

FIG. 4 is a flowchart depicting an example of processing by the second wireless apparatus according to the first embodiment. The second wireless apparatus 120 according to the first embodiment executes steps depicted in FIG. 4, for example. First, the second wireless apparatus 120 receives from the first wireless apparatus 110, a paging message that includes information indicating plural cells (step S401). The paging message received by the second wireless apparatus 120 at step S401 is, for example, the paging message transmitted by the first wireless apparatus 110 at step S302 depicted in FIG. 3.

Next, the second wireless apparatus 120 selects a cell as a connection destination, based on the information that indicates plural cells and is included in the paging message received at step S401 (step S402). When, for example, the information indicating the plural cells is information indicating plural cells to which the second wireless apparatus 120 is to preferentially connect, the second wireless apparatus 120 preferentially selects, as a connection destination, the plural cells indicated by the information included in the paging message. When the information indicating plural cells is information indicating plural cells to which connection is to be preferentially avoided by the second wireless apparatus 120, the second wireless apparatus 120 preferentially selects, as a connection destination, a cell other than the plural cells indicated by the information included in the paging message.

Next, the second wireless apparatus 120 performs processing of connecting to the connection-destination cell selected at step S402 (step S403), ending a series of operations. As a result, the second wireless apparatus 120 can select a connection-destination cell, based on plural cells notified from the first wireless apparatus 110 using the paging message, and connect to the selected connection-destination cell.

In this manner, according to the first embodiment, the first wireless apparatus 110 can include in a paging message and transmit to the second wireless apparatus 120, information indicating a cell related to connection and the second wireless apparatus 120 can perform connection processing to a cell selected based on the information. As a result, the first wireless apparatus 110 can distribute according to the statuses of frequency carriers, connection destinations of wireless apparatuses including the second wireless apparatus 120. As a result, load distribution between cells can be performed according to the statuses of cells as the frequency carriers.

Flexible load distribution becomes possible by the first wireless apparatus 110 transmitting information indicating plural cells related to connection, the information being including in a paging message. For example, by notifying the second wireless apparatus 120 of plural cells having lower loads, the second wireless apparatus 120 can select and connect to a cell satisfying a predetermined communication quality or a cell having a higher communication quality, among the plural cells having lower loads. For example, in a case in which plural cells having higher loads are present, the second wireless apparatus 120 is notified of the plural cells having higher loads so that connection of the second wireless apparatus 120 to the plural cells can be suppressed.

Next, configuration examples corresponding to the first embodiment will be described in second and third embodiments.

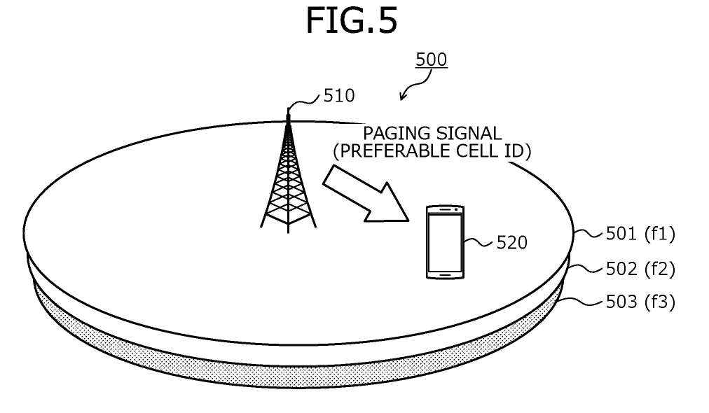

FIG. 5 is a diagram depicting an example of a wireless communications system according to a second embodiment. As depicted in FIG. 5, a wireless communications system 500 according to the second embodiment includes a base station 510 and a terminal 520. The base station 510 is a base station such as an eNB of long term evolution (LTE) for example. The terminal 512 is a terminal such as user equipment (UE) of LTE, for example. Cells 501 to 503 are cells formed by the base station 510. Frequencies of the cells 501 to 503 are frequencies f1 to f3 (f1≠f2≠f3), respectively. In the example depicted in FIG. 5, different frequencies mean different cells (frequency carriers).

When a call of the terminal 520 occurs, the base station 510 performs paging (wireless call) to transition the terminal 520 from an idle mode (idle state) to a connected mode (connected state). The idle and connected modes are radio resource control (RRC) IDLE and RRC CONNECTED defined in TS36.331 V12.3.0, for example.

The base station 510 stores a preferable cell ID to a paging message included in a paging signal transmitted to the terminal 520 at the time of paging. The preferable cell ID is an ID of a cell (preferable cell) to which connection by the terminal 520 is preferable. In other words, the preferable cell ID is information indicating a cell to which the terminal 520 is to preferentially connect.

The paging message transmitted from the base station 510 may include plural preferable cell IDs. In this case, the plural preferable cell IDs may specify a preferential sequence of connection of the terminal 520. For example, the paging message may include an ID (1^{st} preferable cell ID) of a cell to which connection by the terminal 520 is most preferable, an ID (2^{nd} preferable cell ID) of a cell to which connection by the terminal 520 is second most preferable, etc.

For example, when plural base stations 510 are present, the plural base stations 510 can determine respective preferable cells. In other words, the preferable cell ID may differ among the plural base stations 510 each transmitting a paging message.

The base station 510 may determine a preferable cell every time the base station 510 transmits a paging message and include an ID of the determined preferable cell in the paging message. Consequently, each time the paging message is transmitted, a preferable cell ID indicating a cell that is preferable at that time can be transmitted.

For example, the base station 510 selects a preferable cell from among the cells 501 to 503, based on the load statuses (load states) of the cells 501 to 503. The base station 510 then includes an ID (preferable cell ID) of the selected cell in the paging message transmitted to the terminal 520.

As a result, the terminal 520 can be notified of a low-load cell as a preferable cell. As the load status of the cell, for example, the use rate of a resource block (RB), the number of terminals being currently connected to cells (in connected mode), or the data retention amount (buffering amount) in a cell can be used.

When the terminal 520 receives a paging message destined for the terminal 520 from the base station 510, the terminal 520 determines based on a preferable cell ID within the paging message, a cell to which the terminal 520 is to connect and performs processing of connecting to the determined cell. This connection processing is, for example, processing of transmitting a random access signal to the base station (e.g., the base station 510) of the cell determined for connection and connecting to the cell determined for connection.

For example, based on the communication quality (e.g., reception quality) of a preferable cell specified by the preferable cell ID, the terminal 520 determines whether connection to the preferable cell is possible. For example, based on whether the communication quality of a preferable cell exceeds a threshold value, the terminal 520 determines whether connection to the preferable cell is possible.

The communication quality can be, for example, reference signal received power (RSRP), reference signal received quality (RSRQ), or received signal strength indicator (RSSI) (for example, refer to TS36.304 V12.2.0).

When determining that connection to the preferable cell is possible, the terminal 520 connects to the preferable cell. When determining connection to the preferable cell is not possible, the terminal 520 connects to a cell having a best possible condition among cells other than the preferable cell. The cell having the best possible condition is, for example, a cell with the highest communication quality. In this case, the terminal 520 may select a connection-destination cell from among cells other than the preferable cell, based on the priority set for each frequency.

By including a preferable cell ID in a paging message in this manner, it is possible to connect the terminal 520 to a cell having a lower load and perform load distribution of distributing connection-destination cells in the CONNECTED mode. The preferable cell ID may be an ID of a cell of a base station different from the base station 510 or of a remote radio head (RRH). As a result, load distribution with peripheral cells can be performed. Application to heterogeneous network (HetNet) also becomes possible.

The example depicted in FIG. 5 is an example in which a single base station (the base station 510) uses plural frequency carriers and forms plural cells (the cells 501 to 503). The base station 510 acquires load statuses of the cells 501 to 503 that the base station 510 serves and determines a cell preferable for connection to by the terminal 520 from among the cells 501 to 503, includes an ID (preferable cell ID) of the determined cell in a paging message and transmits the ID.

The base station 510 does not have information concerning frequencies at which the terminal 520 stands by. This is because the terminal 520 performs position registration only when the terminal 520 moves across a position registration area including plural cells. Therefore, the base station 510 transmits the paging message destined for the terminal 520, through cells of respective frequencies in the position registration area. Since the paging period can be set for each of the cells, transmission of the paging message at the respective frequencies is not necessarily performed at the same time. The preferable cell ID may differ for each paging message transmitted to the cells.

The first wireless apparatus 110 depicted in FIGS. 1 and 2 can be implemented by the base station 510, for example. The second wireless apparatus 120 depicted in FIGS. 1 and 2 can be implemented by the terminal 520, for example.

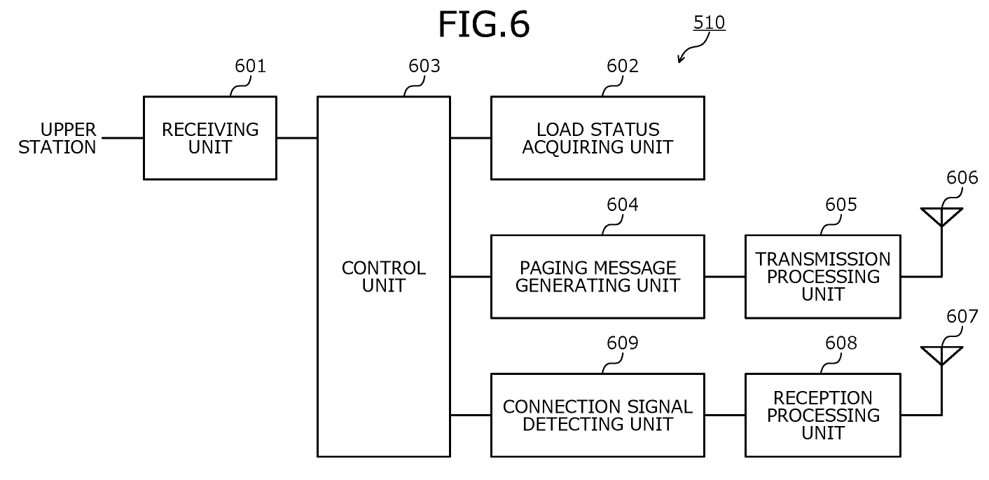

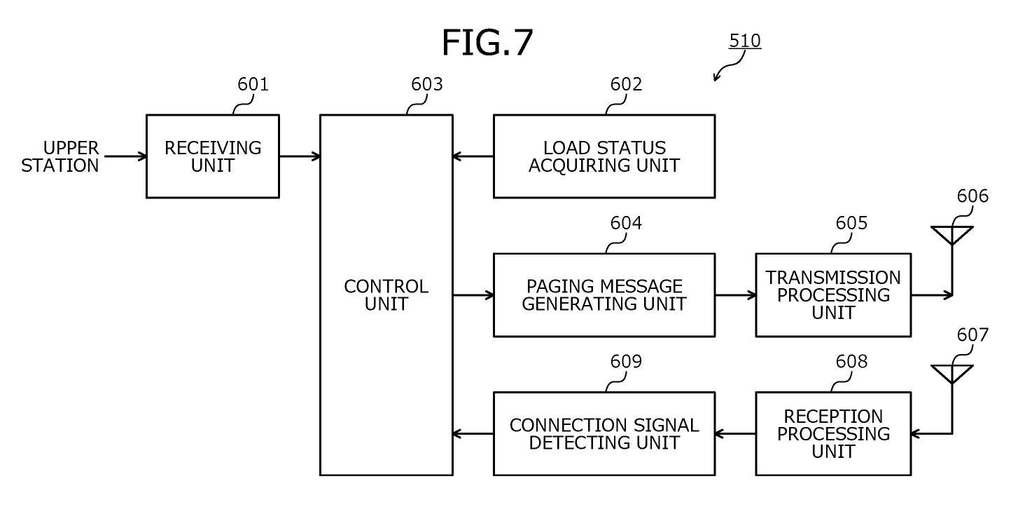

FIG. 6 is a diagram depicting an example of a base station according to the second embodiment. FIG. 7 is a diagram depicting an example of signal flow in the base station depicted in FIG. 6. As depicted in FIGS. 6 and 7, the base station 510 according to the second embodiment is provided with a receiving unit 601, a load status acquiring unit 602, a control unit 603, a paging message generating unit 604, a transmission processing unit 605, and a transmitting antenna 606. The base station 510 is provided with a receiving antenna 607, a reception processing unit 608, and a connection signal detecting unit 609.

The receiving unit 601 receives a control signal from an upper station of the base station 510. The upper station of the base station 510 is a mobility management entity (MME), for example. Reception of the control signal by the receiving unit 601 can be performed using an 51 interface, for example. The control signal received by the receiving unit 601 includes a paging startup request (paging) concerning a subordinate terminal of the base station 510. The receiving unit 601 outputs the received control signal to the control unit 603.

The load status acquiring unit 602 acquires load information indicating the load statuses in the cells of the base station 510. The load information is various types of information indicating the above cell load statuses. For example, the load status acquiring unit 602 can acquire load information concerning a cell of the station, based on, for example, a scheduling process of the station. The load status acquiring unit 602 can acquire load information concerning a cell of another station from the station via an interface between base stations. The interface between base stations can be an X2 interface, for example. The load status acquiring unit 602 outputs the acquired load information to the control unit 603.

When a paging startup request is included in the control signal output from the receiving unit 601, the control unit 603 determines a cell (preferable cell) preferable for connection by a terminal (e.g., the terminal 520) to be paged, based on the load information output from the load status acquiring unit 602. The control unit 603 then outputs an ID (a preferable cell ID) of the determined preferable cell to the paging message generating unit 604.

The paging message generating unit 604 generates a paging message that includes the preferable cell ID output from the control unit 603. The paging message generating unit 604 outputs the generated paging message to the transmission processing unit 605.

The transmission processing unit 605 performs transmission processing of the paging message output from the paging message generating unit 604. The transmission processing by the transmission processing unit 605 includes, for example, conversion from a digital signal to an analog signal, frequency conversion from a baseband to a radio frequency (RF) band, amplification, etc. The transmission processing unit 605 outputs the signal subjected to the transmission processing to the transmitting antenna 606. The transmitting antenna 606 wirelessly transmits to a terminal (e.g., the terminal 520), the signal output from the transmission processing unit 605.

The receiving antenna 607 receives a signal wirelessly transmitted from a terminal (e.g., the terminal 520) and outputs the received signal to the reception processing unit 608. The reception processing unit 608 performs reception processing of the signal output from the receiving antenna 607. The reception processing by the reception processing unit 608 includes, for example, amplification, frequency conversion from a RF band to baseband, and conversion from an analog signal to a digital signal. The reception processing unit 608 outputs the signal subjected to the reception processing to the connection signal detecting unit 609.

The connection signal detecting unit 609 detects a connection signal from the terminal, included in the signal output from the reception processing unit 608. The connection signal from the terminal is, for example, a random access channel (RACH) connection signal transmitted from the terminal 520 in response to the paging message transmitted by the transmitting antenna 606. The connection signal detecting unit 609 outputs the detected connection signal to the control unit 603.

Based on the connection signal output from the connection signal detecting unit 609, the control unit 603 performs processing of connecting a terminal (e.g., the terminal 520) to a cell. As a result, the terminal can be transitioned to the connected mode and connected to the cell.

The generating unit 111 depicted in FIGS. 1 and 2 can be implemented by the control unit 603 and the paging message generating unit 604, for example. The transmitting unit depicted in FIGS. 1 and 2 can be implemented by the transmission processing unit 605 and the transmitting antenna 606, for example.

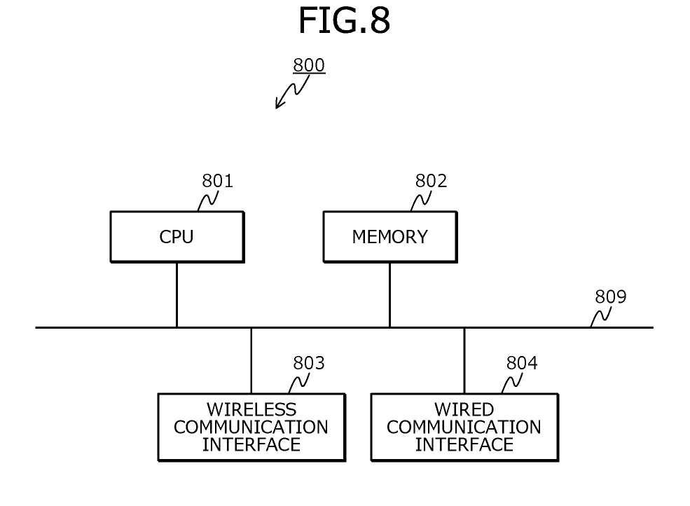

FIG. 8 is a diagram depicting an example of a hardware configuration of a base station. The base station 510 depicted in FIGS. 6 and 7 can be implemented by a communications apparatus 800 depicted in FIG. 8, for example. The communications apparatus 800 is provided with a central processing unit (CPU) 801, a memory 802, a wireless communication interface 803, and a wired communication interface 804. The CPU 801, the memory 802, the wireless communication interface 803, and the wired communication interface 804 are connected to one another via a bus 809.

The CPU 801 provides overall control of the communications apparatus 800. The memory 802 includes a main memory and an auxiliary memory. The main memory is a random access memory (RAM), for example. The main memory is used as a work area of the CPU 801. The auxiliary memory is, for example, a nonvolatile memory such as a magnetic disk, an optical disk, and a flash memory. The auxiliary memory stores various programs operating the communications apparatus 800. The programs stored in the auxiliary memory are loaded onto the main memory and executed by the CPU 801.

The wireless communication interface 803 is a communication interface for wireless communication with an apparatus (e.g., the terminal 520) external to the communications apparatus 800. The wireless communication interface 803 is controlled by the CPU 801.

The wired communication interface 804 is a communication interface for wired communication with an apparatus (e.g., an upper station of the base station 510, or another base station) external to the communications apparatus 800. The wired communication interface 804 is controlled by the CPU 801. The wired communication interface 804 includes a S1 interface and an X2 interface, for example.

The receiving unit 601 depicted in FIGS. 6 and 7 can be implemented by the wired communication interface 804, for example. The load status acquiring unit 602 depicted in FIGS. 6 and 7 can be implemented by the CPU 801 or the wired communication interface 804, for example. The control unit 603, the paging message generating unit 604, and the connection signal detecting unit 609 depicted in FIGS. 6 and 7 can be implemented by the CPU 801, for example. The transmission processing unit 605, the transmitting antenna 606, the receiving antenna 607, and the reception processing unit 608 depicted in FIGS. 6 and 7 can be implemented by the wireless communication interface 803, for example.

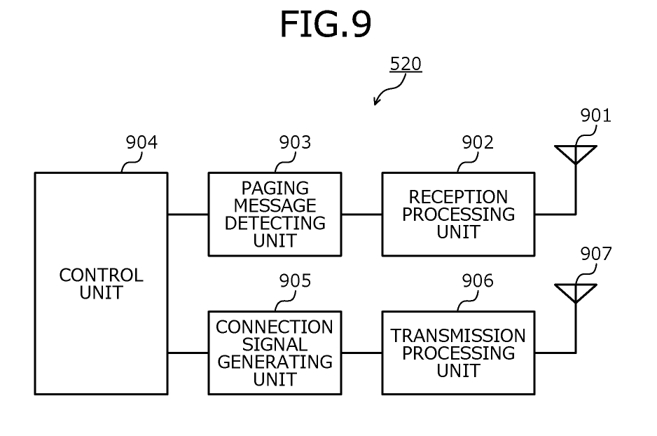

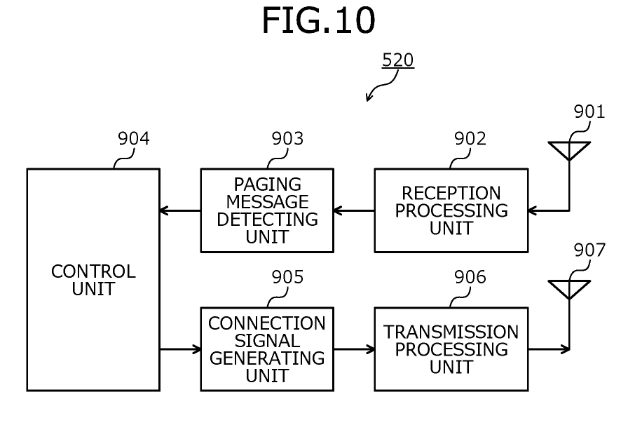

FIG. 9 is a diagram depicting an example of a terminal according to the second embodiment. FIG. 10 is a diagram depicting an example of signal flow in the terminal depicted in FIG. 9. As depicted in FIGS. 9 and 10, the terminal 520 according to the second embodiment is provided with a receiving antenna 901, a reception processing unit 902, a paging message detecting unit 903, a control unit 904, a connection signal generating unit 905, a transmission processing unit 906, and a transmitting antenna 907.

The receiving antenna 901 receives a signal wirelessly transmitted from a base station (e.g., the base station 510) and outputs the received signal to the reception processing unit 902. The reception processing unit 902 performs reception processing of the signal output from the receiving antenna 901. The reception processing by the reception processing unit 902 includes, for example, amplification, frequency conversion from a RF band to a baseband, and conversion from an analog signal to a digital signal. The reception processing unit 902 outputs the signal subjected to the reception processing to the paging message detecting unit 903.

The paging message detecting unit 903 detects a paging message included in the signal output from the reception processing unit 902. The paging message detecting unit 903 then outputs the detected paging message to the control unit 904.

The control unit 904 extracts a preferable cell ID included in the paging message output from the paging message detecting unit 903. When connection to a cell indicated by the extracted preferable cell ID is possible, the control unit 904 determines the cell indicated by the preferable cell ID to be a connection-destination cell. When connection to a cell indicated by the extracted preferable cell ID is not possible, the control unit 904 determines a cell different from the cell indicated by the preferable cell ID to be a connection-destination cell. The control unit 904 then notifies the connection signal generating unit 905 of the cell determined as the connection destination.

The connection signal generating unit 905 generates a connection signal for connection to the connection-destination cell notified from the control unit 904. The connection signal generated by the connection signal generating unit 905 is a RACH connection signal, for example. The connection signal generating unit 905 outputs the generated connection signal to the transmission processing unit 906.

The transmission processing unit 906 performs transmission processing with respect to the connection signal output from the connection signal generating unit 905 and outputs the signal subjected to the transmission processing to the transmitting antenna 907. The transmission processing by the transmission processing unit 906 includes, for example, conversion from a digital signal to an analog signal, frequency conversion from a baseband to a RF band, amplification, etc. The transmitting antenna 907 wirelessly transmits to a base station (e.g., the base station 510), the signal output from the transmission processing unit 906.

The receiving unit 121 depicted in FIGS. 1 and 2 can be implemented, for example, by the receiving antenna 901, the reception processing unit 902, and the paging message detecting unit 903. The control unit 122 depicted in FIGS. 1 and 2 can be implemented, for example, by the control unit 904, the connection signal generating unit 905, the transmission processing unit 906, and the transmitting antenna 907.

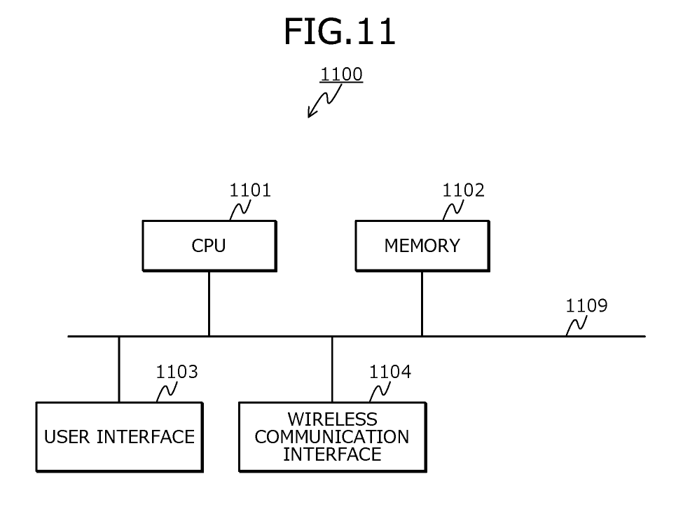

FIG. 11 is a diagram depicting an example of a hardware configuration of a terminal. The terminal 520 depicted in FIGS. 9 and 10 can be implemented by a communication device 1100 depicted in FIG. 11, for example. The communication device 1100 is provided with a CPU 1101, a memory 1102, a user interface 1103, and a wireless communication interface 1104. The CPU 1101, the memory 1102, the user interface 1103, and the wireless communication interface 1104 are connected to one another via a bus 1109.

The CPU 1101 provides overall control of the communication device 1100. The memory 1102 includes a main memory and an auxiliary memory. The main memory is a RAM, for example. The main memory is used as a work area of the CPU 1101. The auxiliary memory is, for example, a nonvolatile memory such as a magnetic disk and a flash memory. The auxiliary memory stores various programs operating the communication device 1100. The programs stored in the auxiliary memory are loaded onto the main memory and are executed by the CPU 1101.

The user interface 1103 includes, for example, an input device that accepts operation input from the user and an output device that outputs information to the user. The input device can be implemented by keys (e.g., a keyboard) or a remote controller, for example. The output device can be implemented by a display or a speaker, for example. A touch panel, etc. may implement the input device and the output device. The user interface 1103 is controlled by the CPU 1101.

The wireless communication interface 1104 is a communication interface for wireless communication with an apparatus (e.g., the base station 510, or another terminal) external to the communication device 1100. The wireless communication interface 1104 is controlled by the CPU 1101.

The receiving antenna 901, the reception processing unit 902, the transmission processing unit 906, and the transmitting antenna 907 depicted in FIGS. 9 and 10 can be implemented by the wireless communication interface 1104, for example. The paging message detecting unit 903, the control unit 904, and the connection signal generating unit 905 depicted in FIGS. 9 and 10 can be implemented by the CPU 1101, for example.

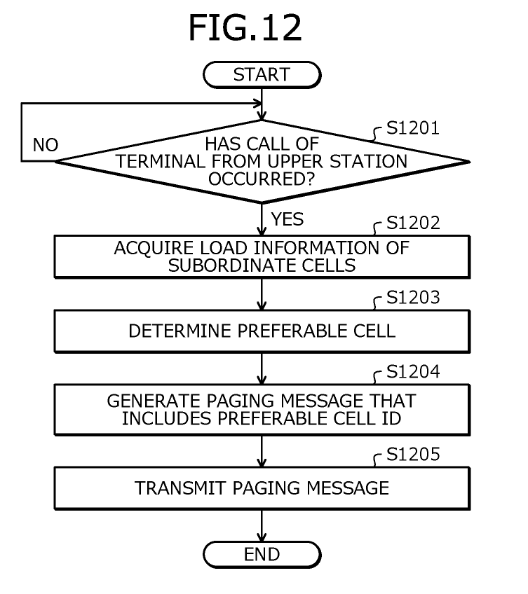

FIG. 12 is a flowchart depicting an example of processing by a base station according to the second embodiment. The base station 510 according to the second embodiment executes steps depicted in FIG. 12, for example. First, the base station 510 determines whether a call of the terminal 520 from an upper station of the base station 510 has occurred (step S1201) and waits until a call of the terminal 520 from the upper station occurs (step S1201: NO). The upper station of the base station 510 is the MME as described above, for example. Whether a call of the terminal 520 from the upper station has occurred can be determined based on, for example, whether a paging startup request has been received from the upper station.

At step S1201, when a call of the terminal 520 from the upper station occurs (step S1201: YES), the base station 510 acquires load information indicating the load statuses of cells subordinate to the base station 510 (step S1202). The base station 510 then determines a preferable cell for the terminal 520, based on the load information acquired at step S1202 (step S1203).

The base station 510 then generates a paging message that includes an ID (a preferable cell ID) indicating the preferable cell determined at step S1203 (step S1204). The base station 510 transmits the paging message generated at step S1204 to the terminal 520 (step S1205), ending a series of operations.

At step S1202, the base station 510 may acquire load information indicating the load statuses of not only the cells subordinate to the base station 510 but also of peripheral cells. In this case, the base station 510 adds the peripheral cells to candidates of a preferable cell determined at step 1203. The load statuses of the peripheral cells can be acquired by using, for example, the interfaces between base stations from peripheral base stations of the base station 510 forming the peripheral cells.

Subsequent to the steps depicted in FIG. 12, in the case of receiving a connection signal transmitted from the terminal 520, the base station 510 performs connection processing of the terminal 520, based on the received connection signal. It is to be noted, however, that in a case where the terminal 520 is not present in the cells of the base station 510 or where the terminal 520 selects, as a connection destination, a cell different from the cells of the base station 510, the terminal 520 does not transmit the connection signal to the base station 510 and the base station 510 does not perform the connection processing of the terminal 520.

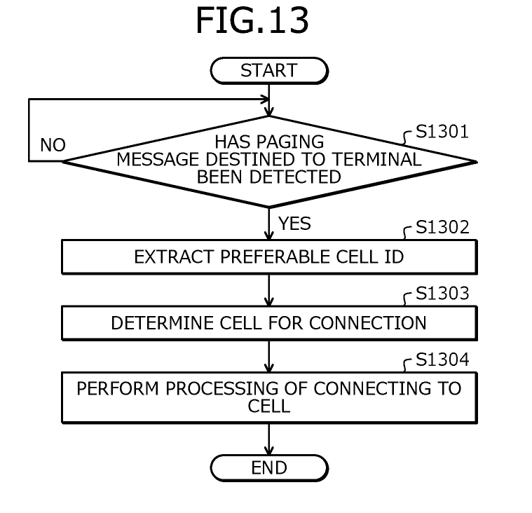

FIG. 13 is a flowchart depicting an example of processing by a terminal according to the second embodiment. The terminal 520 according to the second embodiment executes steps depicted in FIG. 13, for example. First, the terminal 520 determines whether the terminal 520 has detected (received) a paging message destined thereto from the base station 510 (step S1301) and waits until detecting a paging message destined thereto (step S1301: NO).

At step S1301, when detecting a paging message destined for the terminal 520 (step S1301: YES), the terminal 520 extracts a preferable cell ID included in the detected paging message (step S1302).

Next, based on the preferable cell extracted at step S1302, the terminal 520 determines a cell to which the terminal 520 is to connect (step S1303). For example, the terminal 520 determines preferentially, as a cell to which the terminal 520 is to connect, a cell indicated by the extracted preferable cell ID among cells to which the terminal 520 can connect.

The terminal 520 then performs processing of connecting to the cell determined at step S1303 as being the cell to which the terminal 520 is to connect (step S1304), ending a series of operations. At step S1304, for example, the terminal 520 transmits to the base station 510, a RACH connection signal for connection to the cell determined as being the cell to which the terminal 520 is to connect.

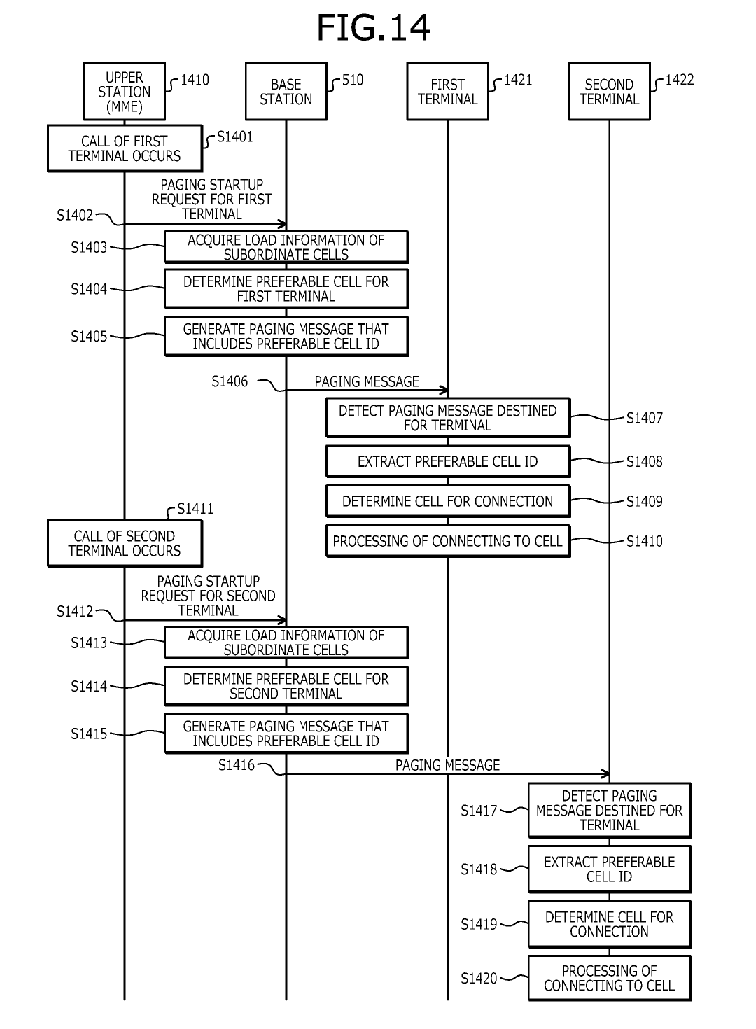

FIG. 14 is a sequence diagram depicting an example of processing by a wireless communications system according to the second embodiment. In the wireless communications system 500 according to the second embodiment, steps depicted in FIG. 14, for example, are executed. An upper station 1410 depicted in FIG. 14 is an upper station of the base station 510 and is, for example, an MME to which the base station 510 connects. A first terminal 1421 and a second terminal 1422 depicted in FIG. 14 are both terminals corresponding to the terminal 520 described above.

First, a call of the first terminal 1421 is assumed to have occurred at the upper station 1410 (step S1401). In this case, the upper station 1410 transmits a paging message requesting a paging startup for the first terminal 1421 to the base station 510 (step S1402). For example, the upper station 1410 uses an S1 application protocol (S1AP) and transmits the paging message to base stations (including the base station 510) in a tracking area of the terminal 520 (for example, refer to TS36.300 V12.3.0).

Next, the base station 510 acquires load information indicating the load statuses of cells subordinate to the base station 510 (step S1403). The base station 510 determines based on the load information acquired at step S1403, a preferable cell for the first terminal 1421 (step S1404).

The base station 510 then generates a paging message that is destined for the first terminal 1421 and includes an ID (a preferable cell ID) indicating the preferable cell determined at step S1404 (step S1405). The base station 510 transmits the paging message generated at step S1405 and destined for the first terminal 1421 (step S1406).

Next, the first terminal 1421 detects the paging message destined thereto transmitted at step S1406 (step S1407). The first terminal 1421 extracts the preferable cell ID included in the paging message detected at step S1407 (step S1408).

The first terminal 1421 determines based on the preferable cell ID extracted at step S1408, a cell to which the first terminal 1421 is to connect (step S1409). The first terminal 1421 then performs processing of connecting to the cell determined at step S1409 as the cell to which the first terminal 1421 is to connect (step S1410).

Next, a call of the second terminal 1422 is assumed to have occurred at the upper station 1410 (step S1411). In this case, the upper station 1410 transmits a paging startup request for the second terminal 1422 to the base station 510 (step S1412).

Next, the base station 510 acquires load information indicating the load statuses of cells subordinate to the base station 510 (step S1413). The base station 510 then determines based on the load information acquired at step S1413, a preferable cell for the second terminal 1422 (step S1414).

The base station 510 then generates a paging message that is destined for the second terminal 1422 and includes an ID (a preferable cell ID) indicating the preferable cell determined at step S1414 (step S1415). The base station 510 transmits the paging message generated at step S1415 and destined for the second terminal 1422 (step S1416).

Next, the second terminal 1422 detects the paging message destined thereto and transmitted at step S1416 (step S1417). The second terminal 1422 extracts the preferable cell ID included in the paging message detected at step S1417 (step S1418).

The second terminal 1422 determines based on the preferable cell ID extracted at step S1418, a cell to which the second terminal 1422 is to connect (step S1419). The second terminal 1422 then performs processing of connecting to the cell determined at step S1419 as the cell to which the second terminal 1422 is to connect (step S1420).

In this manner, in the wireless communications system 500, every time a call of a terminal occurs, a preferable cell is determined based on the load information indicating the load statuses of cells at that time and the paging message is used to notify the called terminal of the preferable cell. As a result, load distribution according to the statuses of the cells becomes possible.

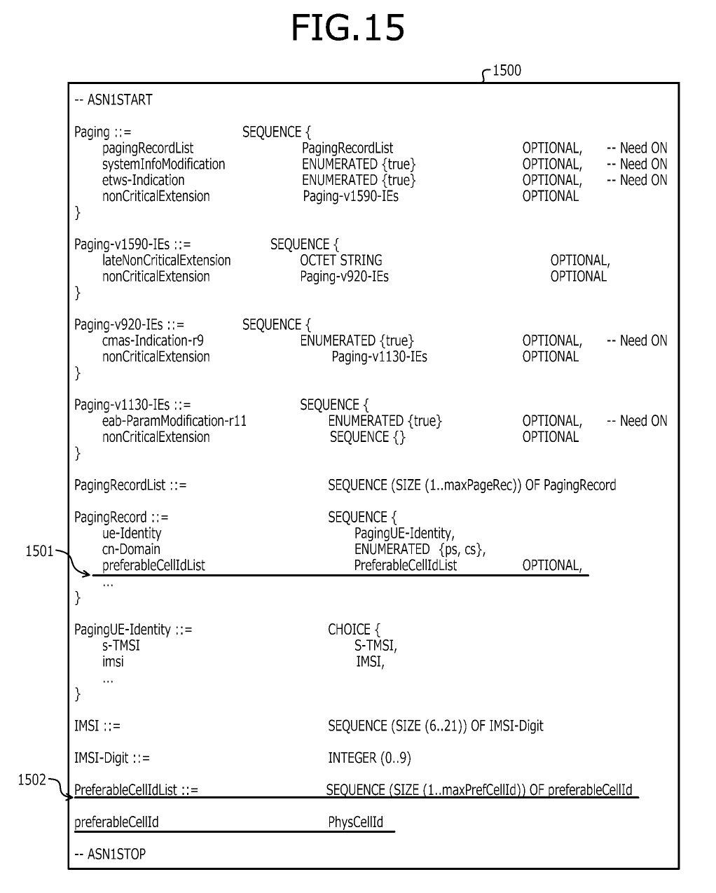

FIG. 15 is a diagram depicting an example of a paging message. A paging message 1500 depicted in FIG. 15 shows a data structure of the paging message transmitted from the base station 510, expressed by abstract syntax notation one (ASN.1). As indicated by reference numerals 1501 and 1502 (underlined parts) in FIG. 15, the base station 510 can store preferable cell IDs into “PagingRecord”, for example, included in the paging message.

The example depicted in FIG. 15 is an example where a preferable cell ID field is added to a paging message defined in TS36.331 V12.3.0, for example. “PagingRecordList” depicted in FIG. 15 is information for a terminal call. “PagingRecord” includes “ue-Identity” and “cn-Domain”.

“ue-Identity” is identification information of a terminal to be called. “ue-Identity” is represented by, for example, SAE temporary mobile station identity (S-TMSI) or international mobile subscriber identity (IMSI).

S-TMSI is a 40-bit sequence. The 40-bit sequence consists of an 8-digit MME ID and a temporary 32-digit UE ID. IMSI is 6 to 21 decimal-digit identification information. “cn-Domain” is information indicating whether the caller is a packet switched network or a circuit switched network.

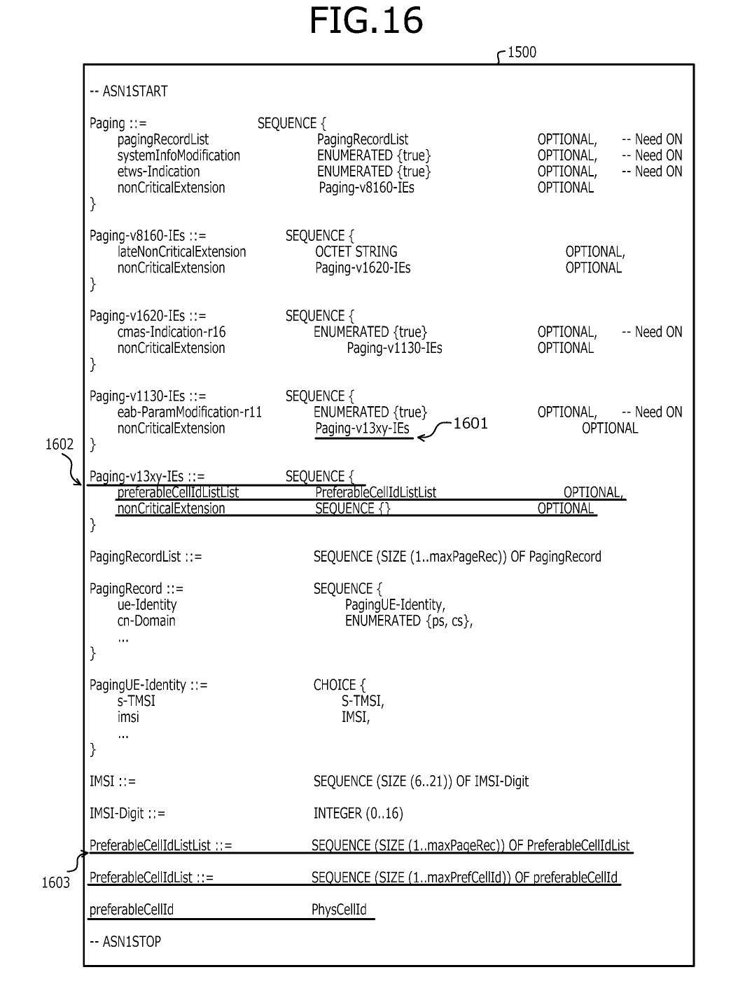

FIG. 16 is a diagram depicting another example of the paging message. The base station 510 may transmit the paging message 1500 depicted in FIG. 16, for example. As indicated by reference numerals 1601 to 1603 (underlined parts) depicted in FIG. 16, the base station 510 may store preferable cell IDs into “nonCriticalExtension” of the paging message 1500. “13xy” represents a version number. Thus, without adding a new field to the paging message defined in TS36.331 V12.3.0, for example, the preferable cell ID can be stored in the paging message.

In the example depicted in FIGS. 15 and 16, a 9-bit physical cell identity (PCI) allocated to the cells, for example, can be used for the preferable cell ID. The preferable cell ID may be some bits of PCI. As a result, an increase in the overhead can be suppressed. Some bits of PCI are lower X bits (X is 1 to 8), for example. In this case, in the cell planning, PCIs having the same lower X bits are not be allocated to cells formed by the same base station or neighbor base stations.

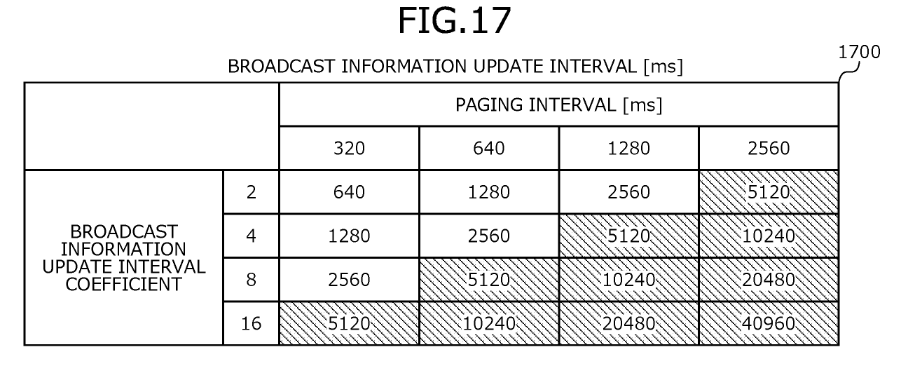

FIG. 17 is a diagram depicting an example of a broadcast information update interval. A table 1700 depicted in FIG. 17 shows an update interval [ms] of broadcast information transmitted from the base station 510. In the table 1700, a paging interval [ms] is a paging interval settable in the base station 510 and is a time interval of paging transmission opportunity. A broadcast information update interval coefficient is a coefficient settable in the base station 510 and is a coefficient multiplied to the paging interval.

The update interval of broadcast information in the base station 510 is determined, for example, by multiplication of the paging interval and the broadcast information update interval coefficient as depicted in the table 1700. For example, when the paging interval is set to 320 [ms] with the broadcast information update interval coefficient of 2 in the base station 510, the update interval of the broadcast information is 640 [ms].

As an example, a case will be described where 1000 terminals (including the terminal 520, for example) are currently connecting in idle state to the base station 510, with the call interval being 1 hour per terminal. In this case, the average call interval of any one terminal is 3.6 sec.

For example, the preferable cell ID is assumed to be transmitted by the broadcast information, when the load statuses of connection candidate cells vary, the update interval of the broadcast information becomes longer than 3.6 sec. in combinations indicated by hatched lines in table 1700. Therefore, the updating of the preferable cell cannot catch up with the average call interval of any one terminal. In this case, for example, the terminal 520 may select a heavily loaded cell, leading to a reduction of throughput, occurrence of call loss, etc.

In contrast, the paging interval is 320 to 2560 [ms], which is ½ to 1/16 of the broadcast information update interval, for example. Accordingly, by the base station 510 transmitting the preferable cell ID by the paging message, the terminal 520 can be notified of a preferable cell selected according to the most recent load statuses. Therefore, it is possible to connect the terminal 520 to a lightly loaded cell and distribute the loads of cells to thereby suppress a decrease in throughput and an occurrence of call loss.

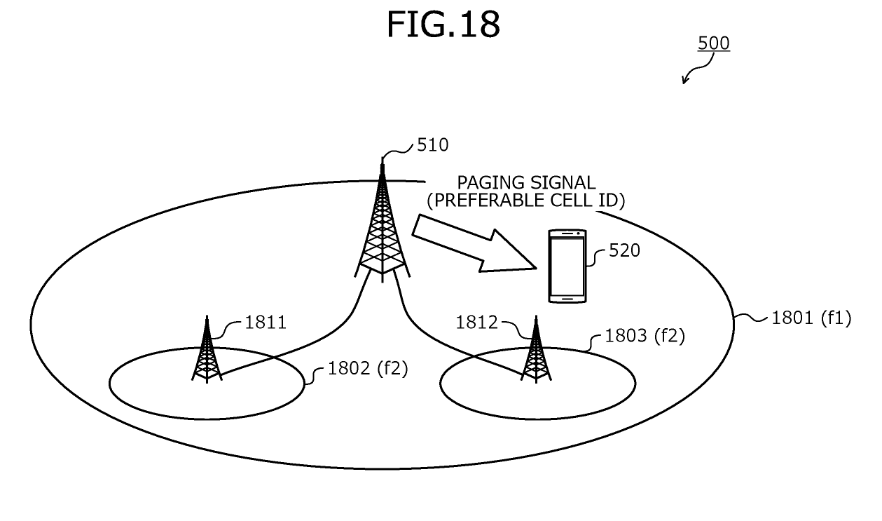

FIG. 18 is a diagram depicting a first modified example of a wireless communications system according to the second embodiment. In FIG. 18, parts similar to those depicted in FIG. 5 are indicated by the same reference numerals used in FIG. 5 and explanations thereof will be omitted. As depicted in FIG. 18, the wireless communications system 500 may be configured to form small cells 1802 and 1803 within an area of a macrocell 1801. In the example depicted in FIG. 18, the base station 510 is a macro base station forming the macrocell 1801. The macrocell 1801 is a cell having a frequency f1.

Base stations 1811 and 1812 are, for example, small base stations forming the small cells 1802 and 1803 within the area of the macrocell 1801. Each of the small cells 1802 and 1803 is a cell having a frequency f2 different from the frequency f1, for example. Cell IDs of the macrocell 1801 and the small cells 1802 and 1803 are different IDs.

In this case, the base station 510 acquires load information indicating the load statuses of the small cells 1802 and 1803 from the base stations 1811 and 1812, respectively, via interfaces between base stations. The base station 510 then determines a preferable cell of the terminal 520 from among the macrocell 1801 and the small cells 1802 and 1803, based on the load information of the macrocell 1801 of the base station 510 and on the load information acquired from the base stations 1811 and 1812.

As described above, the base station 510 does not have information concerning frequencies at which the terminal 520 stands by. For this reason, the base station 510 transmits a paging message destined for the terminal 520 by cells having respective frequencies in the position registration area. Since the paging period can be set for each of the cells, the transmission of the paging message at respective frequencies is not necessarily performed at the same time. A different preferable cell ID may be issued for each of the paging messages transmitted to the cells.

Although a case has been described where the base station 510 forms the macrocell 1801, configuration may be such that the base station 510 forms plural cells. In the same manner, each of the small cells 1802 and 1803 may form plural cells.

In the configuration depicted in FIG. 18, the base stations 1811 and 1822 may be replaced by antennas or RRHs of the base station 510, spaced apart geographically from the base station 510, so that the antennas or the RRHs may form the small cells 1802 and 1803.

In this case, the base station 510 acquires load information indicating the load statuses of the small cells 1802 and 1803 formed by the antennas or RRHs of the base station 510 and determines a preferable cell of the terminal 520, based on the acquired load information.

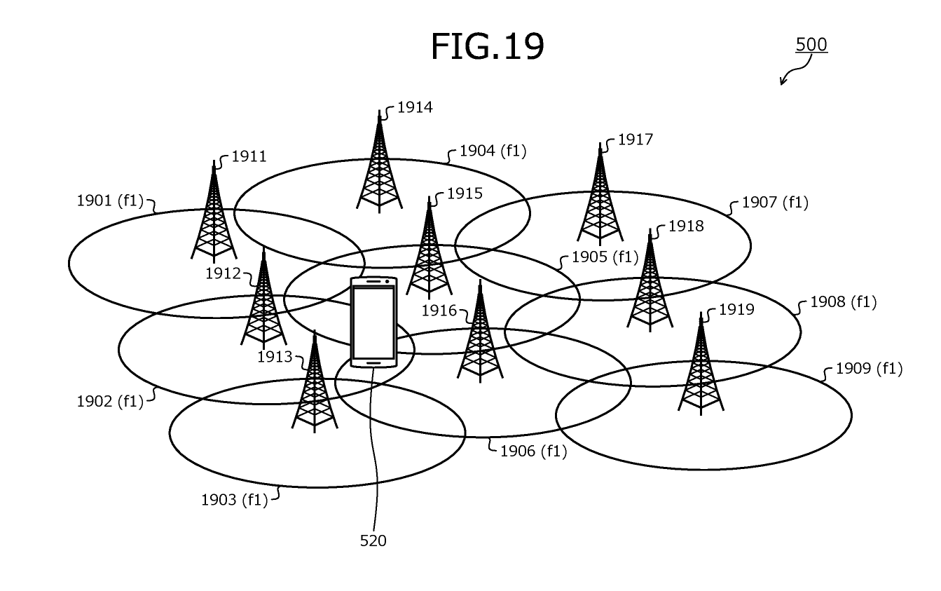

FIG. 19 is a diagram depicting a second modified example of a wireless communications system according to the second embodiment. In FIG. 19, parts similar to those depicted in FIG. 5 are indicated by the same reference numerals used in FIG. 5 and explanations thereof will be omitted. As depicted in FIG. 19, the wireless communications system 500 may be configured such that small cells 1901 to 1909 are densely deployed (formed). In the example depicted in FIG. 19, the wireless communications system 500 includes base stations 1911 to 1919.

The base stations 1911 to 1919 are each a base station corresponding to the base station 510 described above and are small base stations forming the small cells 1901 to 1909, respectively. In the example depicted in FIG. 19, the small cells 1901 to 1909 are each a cell having a frequency f1. The small cells 1901 to 1909 may have frequencies different from one another. The small cells 1901 to 1909 depicted in FIG. 19 may be overlapped by a macrocell.

As an example, a case will be described where the base station 1915 receives a paging startup request for the terminal 520 from an upper station of the base station 1915. The upper station of the base station 1915 is the MME, for example. Alternatively, the upper station of the base station 1915 may be a macro base station.

The base station 1915 acquires load information of the small cell 1905 of the base station 1915 and of cells (e.g., the small cells 1901, 1902, 1904, 1906 to 1908) of neighbor base stations of the base station 1915. The load information of cells of neighbor base stations of the base station 1915 can be acquired via the interfaces between base stations from the neighbor base stations (e.g., the base stations 1911, 1912, 1914, 1916 to 1918) of the base station 1915, for example.

The base station 1915 determines a preferable cell of the terminal 520, based on the acquired load information. As described above, the base station 1915 (the base station 510) does not have information concerning frequencies at which the terminal 520 stands by. For this reason, the base station 1915 transmits a paging message destined for the terminal 520, through cells having respective frequencies in the position registration area. Since the paging period can be set for each of the cells, the transmission of the paging message at the respective frequencies is not necessarily performed at the same time. The preferable cell ID may differ for each paging message transmitted to the cells.

Although a case has been described where the base stations 1911 to 1919 form the small cells 1901 to 1909, respectively, configuration may be such that each of the base stations 1911 to 1919 forms plural small cells.

In the configuration depicted in FIG. 19, the base stations 1911 and 1919 may be replaced by antennas or RRHs of the base station 510 (the macrocell), spaced apart geographically from the base station 510, so that the antennas or the RRHs may form the small cells 1901 and 1909.

In this case, the base station 510 acquires load information indicating the load statuses of the small cells 1901 to 1909 formed by the antennas or RRHs of the base station 510 and determines a preferable cell of the terminal 520, based on the acquired load information.

Thus, according to the second embodiment, the base station (e.g., the base station 510) can include in the paging message and transmit to the terminal (e.g., the terminal 520), a preferable cell ID indicating a cell preferable for connection. The terminal (e.g., the terminal 520) can perform processing of connecting to a cell selected based on the preferable cell ID. As a result, the base station can distribute connection destinations of terminals according to the statuses of the frequency carriers. Therefore, load distribution between cells can be performed according to the statuses of cells as the frequency carriers.

A third embodiment will be described with respect to parts differing from the second embodiment. In the second embodiment, a case is described where the base station 510 stores to a preferable cell ID to a paging message and transmits the preferable cell ID indicating a cell (a preferable cell) preferable for connection. In contrast, in the third embodiment, a case will be described where the base station 510 stores to an unfavorable cell ID to a paging message and transmits the unfavorable cell ID of a cell (an unfavorable cell) unfavorable for connection.

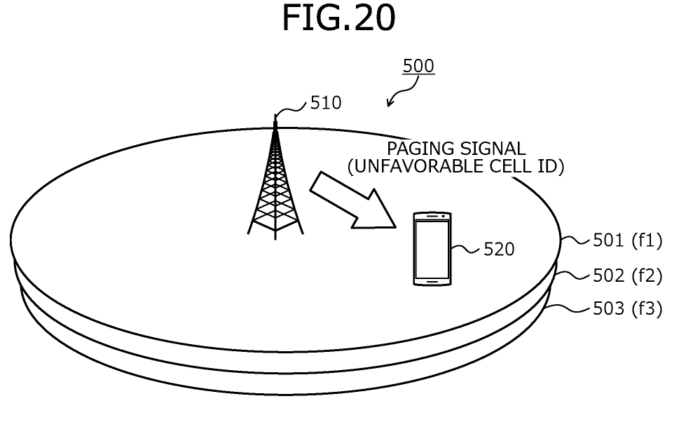

FIG. 20 is a diagram depicting an example of a wireless communications system according to the third embodiment. In FIG. 20, parts similar to those depicted in FIG. 5 are indicated by the same reference numerals used in FIG. 5 and explanations thereof will be omitted. As depicted in FIG. 20, the base station 510 stores an unfavorable cell ID to a paging message that is included in a paging signal transmitted to the terminal 520 at the time of paging. The unfavorable cell ID is an ID of a cell (an unfavorable cell) unfavorable for connection by the terminal 520. In other words, the unfavorable cell ID is information indicating a cell to which connection is to be preferentially avoided by the terminal 520.

The paging message transmitted from the base station 510 may include plural unfavorable cell IDs. In this case, the plural unfavorable IDs may specify an unfavorable connection sequence of the terminal 520. For example, the paging message may include an ID (a 1^{st} unfavorable cell ID) of a cell to which connection by the terminal 520 is most unfavorable, an ID (a 2^{nd} unfavorable cell ID) of a cell to which connection is second most unfavorable, etc.

For example, when plural base stations 510 are present, the plural base stations 510 can determine unfavorable cells. Accordingly, the unfavorable cell ID may differ for each of the plural base stations 510 transmitting a paging message.

The base station 510 may determine an unfavorable cell for each transmission of a paging message and store an ID of the determined unfavorable cell into the paging message. As a result, every time the paging message is transmitted, an unfavorable cell ID indicating a cell unfavorable at that time can be transmitted.

For example, based on the load statuses (load states) of the cells 501 to 503, the base station 510 selects an unfavorable cell from among the cells 501 to 503. The base station 510 then stores an ID (an unfavorable cell ID) of the selected cell into a paging message transmitted to the terminal 520. Hence, the terminal 520 can be notified of a crowded cell as an unfavorable cell.

When the terminal 520 receives a paging message destined to the terminal 520 from the base station 510, the terminal 520 determines based on the unfavorable cell ID in the paging message, a cell to which the terminal 520 is to connect and performs processing of connecting to the determined cell.

For example, based on communication quality (e.g., reception quality) of cells other than the unfavorable cell indicated by the unfavorable cell ID, among cells to which the terminal 520 can connect, the terminal 520 determines whether connection to a cell other than the unfavorable cell is possible.

When determining that connection to a cell other than the unfavorable cell is possible, the terminal 520 connects to the cell other than the unfavorable cell. When determining that connection to a cell other than the unfavorable cell is not possible, the terminal 520 connects to the unfavorable cell.

In this manner, by storing the unfavorable cell ID into the paging message, it is possible to suppress connection of the terminal 520 to a heavily loaded cell and to perform load distribution of distributing connection-destination cells in the CONNECTED mode.

For example, the base station 510 determines, as an unfavorable cell, a cell having less free radio resources among plural cells to which the terminal 520 can connect. This enables the terminal 520 to be notified of a less free cell as an unfavorable cell.

When the terminal 520 receives a paging message destined for the terminal 520 from the base station 510, the terminal 520 determines based on the unfavorable cell ID stored in the paging message, a cell to which the terminal 520 is to connect and performs processing of connecting to the determined cell.

For example, on the basis of the communication quality (e.g., reception quality) of cells, when the terminal 520 can connect to a cell other than a cell specified by the unfavorable cell ID, the terminal 520 connects to the cell other than the cell specified by the unfavorable cell ID. When the terminal 520 cannot connect to a cell other than the cell specified by the unfavorable cell ID, the terminal 520 connects to the cell specified by the unfavorable cell ID.

Similar to the example depicted in FIG. 5, the example depicted in FIG. 20 is an example in which a single base station 510 uses plural frequency carriers to form plural cells. On the contrary, the wireless communications system 500 according to the third embodiment may be configured such that the small cells 1802 and 1803 are formed within the area of the macrocell 1801, as depicted in FIG. 18, for example. The wireless communications system 500 according to the third embodiment may be configured such that the small cells 1901 to 1909 are densely deployed (formed) as depicted in FIG. 19 for example.

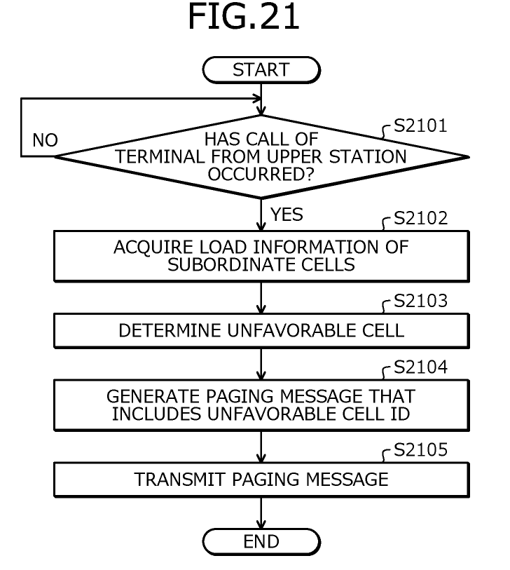

FIG. 21 is a flowchart depicting an example of processing by a base station according to the third embodiment. The base station 510 according to the third embodiment executes steps depicted in FIG. 21, for example. Steps S2101 and S2102 depicted in FIG. 21 are similar to steps S1201 and S1202 depicted in FIG. 12. Subsequent to step S2102, the base station 510 determines an unfavorable cell for the terminal 520, based on the load information acquired at step S2102 (step S2103).

The base station 510 then generates a paging message that includes an ID (an unfavorable cell ID) indicating the unfavorable cell determined at step S2103 (step S2104). The base station 510 transmits the paging message generated at step S2104 to the terminal 520 (step S2105), ending a series of operations.

At step S2102, the base station 510 may acquire load information indicating the load statuses of not only the cells subordinate to the base station 510 but also of peripheral cells. In this case, the base station 510 adds the peripheral cells to unfavorable cell candidates determined at step S2103.

After the steps depicted in FIG. 21, when receiving a connection signal transmitted from the terminal 520, the base station 510 performs connection processing of the terminal 520, based on the received connection signal. When the terminal 520 is not present in a cell of the base station 510 or when the terminal 520 selects, as a connection destination, a cell different from the cells of the base station 510, the terminal 520 does not transmit a connection signal to the base station 510 and the base station 510 does not perform the connection processing of the terminal 520.

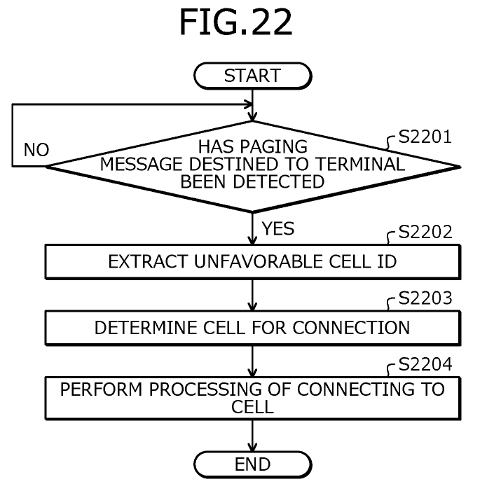

FIG. 22 is a flowchart depicting an example of processing by a terminal according to the third embodiment. The terminal 520 according to the third embodiment executes steps depicted in FIG. 22, for example. Step S2201 depicted in FIG. 22 is similar to step S1301 depicted in FIG. 13. When detecting a paging message destined for the terminal 520 at step S2201 (step S2201: YES), the terminal 520 extracts an unfavorable cell ID included in the detected paging message (step S2202).

The terminal 520 then determines based on the unfavorable cell ID extracted at step S2202, a cell to which the terminal 520 is to connect (step S2203). For example, the terminal 520 determines preferentially, as a cell to which the terminal 520 is to connect, a cell different from the cell indicated by the extracted unfavorable cell ID among cells to which the terminal 520 can connect.

The terminal 520 then performs processing of connecting to the cell determined at step S2203 as the cell to which the terminal 520 is to connect (step S2204), ending a series of operations. At step S2204, for example, the terminal 520 transmits to the base station 510, a RACH connection signal for connection to the cell determined as a cell to which the terminal 520 is to connect.

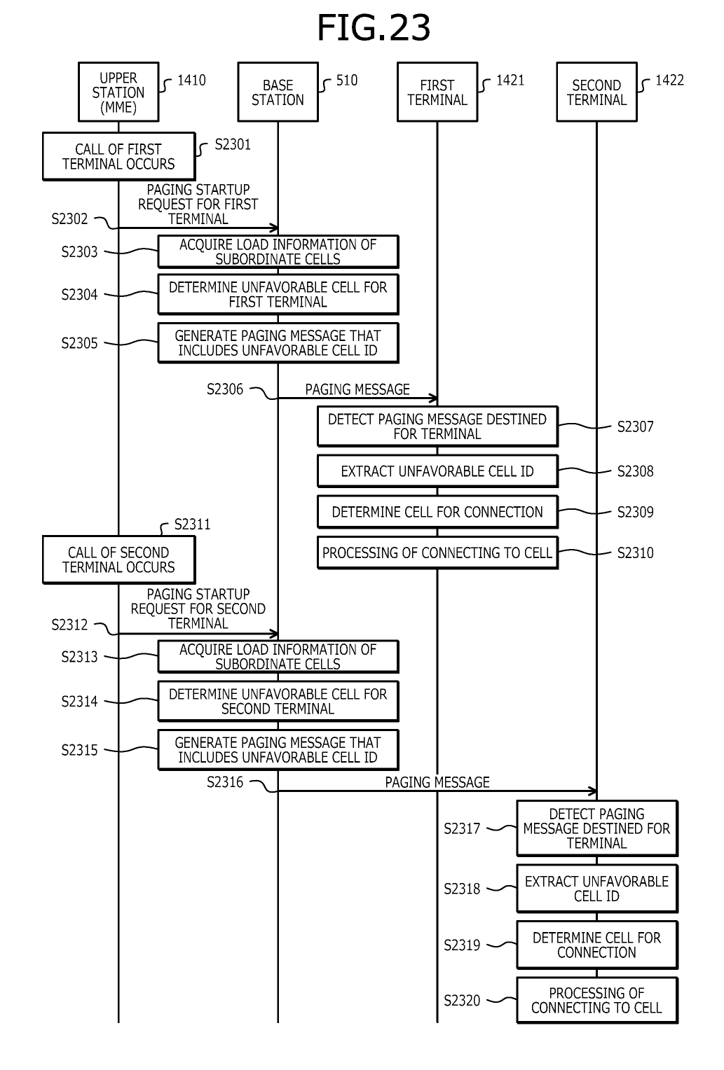

FIG. 23 is a sequence diagram depicting an example of processing by a wireless communications system according to the third embodiment. In FIG. 23, parts similar to those depicted in FIG. 14 are indicated by the same reference numerals used in FIG. 14 and explanations thereof will be omitted. In the wireless communications system 500 according to the third embodiment, steps depicted in FIG. 23, for example, are executed.

Steps S2301 to S2303 depicted in FIG. 23 are similar to steps S1401 to S1403 depicted in FIG. 14. Subsequent to step 2303, the base station 510 determines an unfavorable cell for the first terminal 1421, based on the load information acquired at step S2303 (step S2304). The base station 510 then generates a paging message that includes an ID (an unfavorable cell ID) indicating the unfavorable cell determined at step S2304 (step S2305).

Steps S2306 and S2307 depicted in FIG. 23 are similar to steps S1406 and S1407 depicted in FIG. 14. Subsequent to step S2307, the first terminal 1421 extracts the unfavorable cell ID included in the paging message detected at step S2307 (step S2308).

The first terminal 1421 determines based on the unfavorable cell ID extracted at step S2308, a cell to which the first terminal 1421 is to connect (step S2309). The first terminal 1421 then performs processing of connecting to the cell determined at step S2309 as a cell to which the first terminal 1421 is to connect (step S2310).

Steps S2311 to S2313 depicted in FIG. 23 are similar to steps S1411 to S1413 depicted in FIG. 14. Subsequent to step S2313, the base station 510 determines an unfavorable cell for the second terminal 1422, based on load information acquired at step S2313 (step S2314). The base station 510 then generates a paging message that includes an ID (an unfavorable cell ID) indicating the unfavorable cell determined at step S2314 (step S2315).

Steps S2316 and S2317 depicted in FIG. 23 are similar to steps S1416 and S1417 depicted in FIG. 14. Subsequent to step S2317, the second terminal 1422 extracts the unfavorable cell ID included in a paging message extracted at step S2317 (step S2318).

The second terminal 1422 then determines based on the unfavorable cell ID extracted at step S2318, a cell to which the second terminal 1422 is to connect (step S2319). The second terminal 1422 then performs processing of connecting to the cell determined at step S1219 as the cell to which the second terminal 1422 connects (step S2320).

In this manner, according to the third embodiment, the base station (e.g., the base station 510) can include in a paging message and transmit to the terminal (e.g., the terminal 520), an unfavorable cell ID indicating a cell unfavorable for connection. The terminal (e.g., the terminal 520) can perform connection processing to a cell selected based on the unfavorable cell ID.

Accordingly, in the second embodiment, the terminal can be notified of a cell preferable for connection and the terminal can be preferentially connected to the cell, whereas in the third embodiment, the terminal can be notified of a cell unfavorable for connection and the terminal can be caused to preferentially avoid a connection to the cell. Thus, according to the third embodiment, similar to the second embodiment, the base station can distribute the connection destinations of the terminals according to the statuses of the frequency carriers and load distribution between cells can be performed according to the statuses of the cells of the frequency carriers.

As set forth hereinabove, according to the wireless communications system, the wireless apparatus, and the processing method, the load distribution between cells can be performed according to the statuses of the cells.

For example, in cell selection, it is also conceivable for the base station to set frequency priorities for a terminal by using broadcast information, etc. In this case, however, since the priority information is information common to the terminals, concentration (uneven distribution of idle terminals) at a cell of a frequency carrier with high priority may occur.

To distribute the terminals between the frequency carrier cells, it is conceivable to specify selection probabilities of the cells by broadcast information. Due to a long update interval (e.g., 640 to 40960 [ms]) of the broadcast information, however, a delay may occur in responding to a case where the load status has varied. In this case, a lower throughput or a call loss may occur. The control using the selection probability may bring about a deviation from a target probability.

Since standby (IDLE) terminals are future connected (CONNECTED) terminals candidates, a concentration of number of the idle terminals results in a concentration of future connected terminals, which causes a concentration of load at a specific frequency carrier cell. Therefore, there may be cases in which radio resources cannot be used efficiently.

On the contrary, according to the embodiments described above, it becomes possible to individually set a preferable cell or an unfavorable cell for each paging message. Therefore, a concentration of load at a specific cell can be avoided. The load distribution control according to the load statuses (the extent of congestion) of the cells at the time becomes possible.

As compared with the method of setting the selection probability by broadcast information, for example, use of the paging message can reduce the control interval. Therefore, it is possible to quickly respond to load status variations, suppress a concentration of load at a specific frequency carrier cell, and efficiently use the radio resources.

As compared with the method of performing the handover after a temporary connection to an arbitrary cell, for example, the complexity in signaling and processing accompanying the handover can be avoided.

The above embodiments can achieve load distribution between cells according to the statuses of the cells at the time of arrivals such as arrival of an incoming call, arrival of an incoming mail, arrival of a push notification in an interactive app, for example. The mail includes e-mail and short message service (SMS), for example. According to the embodiments described above, a load distribution between cells according the statuses of the cells can be performed in, for example, a sensor network at the time of, for example, reception of a measurement instruction at a sensor when the measurement instruction is transmitted from the network to the sensor.

The embodiments described above can be used in place of conventional techniques such as setting priority for each of frequencies, for example. Alternatively, the above embodiments may be used in combination with conventional techniques. This ensures a quick response to load status variations. Provided that uneven distribution of idle mode terminals remains left in the configuration, for example, where the priority is used for each of the frequencies, the unevenness can be corrected by combining the above embodiments.

However, with the conventional techniques above, in a configuration, for example, where a base station forms plural cells, idle terminals may concentrate in a specific cell, making it difficult to distribute loads between cells according to the status of cells such as a load status of the cells.

According to one aspect of the present invention, an effect is provided in that load distribution between cells can be performed according to the status of cells.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A wireless communications system comprising:
a first wireless apparatus and a second wireless apparatus, wherein
the first wireless apparatus transmits a paging message that includes information indicating a plurality of cells, the paging message causing the second wireless apparatus to transition from an idle state to a connected state, and
the second wireless apparatus performs processing of connecting to a cell selected based on the information included in the paging message transmitted from the first wireless apparatus.

2. The wireless communications system according to claim 1, wherein
the first wireless apparatus transmits the paging message that includes the information indicating a cell selected according to load statuses of the connection candidate cells, from among connection candidate cells.

3. The wireless communications system according to claim 1, wherein
the first wireless apparatus transmits the paging message that includes information capable of specifying priorities of connection in the plurality of cells.

4. The wireless communications system according to claim 1, wherein
the first wireless apparatus transmits the paging message that includes information indicating the plurality of cells to which the second wireless apparatus is to preferentially connect.

5. The wireless communications system according to claim 1, wherein
the first wireless apparatus transmits the paging message that includes information indicating the plurality of cells to which connections are to preferentially be avoided by the second wireless apparatus.

6. The wireless communications system according to claim 1, wherein
when at least any of the plurality of cells satisfies a predetermined condition, the second wireless apparatus performs the processing of connecting to a cell satisfying the predetermined condition among the plurality of cells, and
when none of the plurality of cells satisfies the predetermined condition, the second wireless apparatus performs the processing of connecting to a cell different from the plurality of cells among connectable cells.

7. The wireless communications system according to claim 1, wherein
when a different cell from the plurality of cells among connectable cells satisfies a predetermined condition, the second wireless apparatus performs the processing of connecting to the different cell, and
when the different cell does not satisfy the predetermined condition, the second wireless apparatus performs the processing of connecting to at least any of the plurality of cells.

8. The wireless communications system according to claim 1, wherein
the plurality of cells is a plurality of cells selected from among cells including cells formed by a wireless apparatus different from the first wireless apparatus.

9. A wireless apparatus capable of communicating with another wireless apparatus, the wireless apparatus comprising:
a generator configured to generate a paging message that includes information indicating a plurality of cells and that causes the another wireless apparatus to transition from an idle state to a connected state; and
a transmitter configured to transmit the paging message generated by the generator.

10. A wireless apparatus comprising:
a receiver configured to receive from another wireless apparatus, a paging message that include information indicating a plurality of cells and that causes the wireless apparatus to transition from an idle state to a connected state; and
a controller configured to perform processing of connecting to a cell selected based on the information included in the paging message received by the receiver.
